(19) United States
(12) Patent Application Publication
(10) Pub. No.: US 2002/0178283 A1
(43) Pub. Date: Nov. 28, 2002

(54) Real-time networking protocol

(75) Inventor: Stephen L. Robinson, Fresno, CA (US)

Correspondence Address: MARK D MILLER, KIMBLE, MACMICHAEL & UPTON, 5260 NORTH PALM AVENUE, SUITE 221, FRESNO, CA, 93704, US

(73) Assignee: Pelco, a partnership

(21) Appl. No.: 09/823,338

(22) Filed: Mar. 29, 2001

(51) Int. Cl. G06F 15/16

(52) U.S. Cl. 709/236

(57) ABSTRACT

The present invention is an efficient protocol designed primarily for use in real-time communications systems involving the transmission of large numbers of short messages, allowing the user interface to have immediate and complete control over a device. The protocol utilizes a unique cascading token passing system for granting the right to control access to the transmission media. Sequential devices on a queue pass the token to each other in sequence, and a master device restarts the sequence each time the end of the sequence is reached. The master is also capable of giving priority to selected devices in the queue. The master device keeps track of skips in the queue (from failed or non-present devices) as well as the location of the end of the queue, and also periodically checks for new devices in the queue, checks the status of “dead” devices in the queue, and checks for devices added to the end of the queue. The master is capable of maintaining and reporting all such status information.

### BACKGROUND OF THE INVENTION

1. Field of the Invention

The present invention relates generally to communication protocols used on a shared media network, and more particularly relates to such a communication protocol having a unique addressing scheme and a unique media access control (MAC) methodology.

2. Description of the Prior Art

Closed circuit television (CCTV) security systems require real-time control of devices. This requirement creates some unique considerations for protocol design, and specifically for the MAC layer of the protocol. The protocol must ensure that bandwidth is used efficiently so that the user interface has immediate and complete control over a device, such as a joystick used to control the pan and tilt of a surveillance camera. Any perceptible lag will be distracting and frustrating to the operator. Typical figures for the maximum acceptable lag indicate that delays longer than 1/20th of a second are objectionable.

The MAC layer of a CCTV system will typically be involved in the transmission of very large numbers of very short messages between the different devices in the system, as compared with the transmission of only a few longer messages. As a result, there is a need for a MAC layer protocol that is specifically designed for efficient handling of these large numbers of short messages.

A critical element of any communications protocol design is how the system handles control over access to the transmission medium. Each device must be granted control and must give up control by some formalized mechanism. Many systems use a random access technique that is inadequate and inappropriate for real-time systems such as those used in the CCTV industry. Other systems that provide better system control tend to increase the overhead of the system by issuing separate, discrete and specific messages that: request, grant, and return control over the media to a “master”. The sheer volume of these discrete messages can tend to clog the available bandwidth, especially where multiple devices share the same bus, resulting in unacceptable delays for real-time systems.

The protocol of U.S. Pat. No. 5,235,592 is connection oriented such that the source and destination devices establish a connection, communicate for a while, and then drop the connection. While no addressing is needed during the connection, this type of protocol requires overhead at the beginning and at the end of each connection. This is appropriate for devices that need to communicate for relatively long periods of time; however, it is not suitable for CCTV applications involving a large volume of short messages.

The method of U.S. Pat. No. 4,747,100 describes adding and deleting stations from a peer ring network using an active node table in each device. Maintaining such a table presents a serious handicap for high speed, small, distributed systems such as those used in CCTV. The switching mechanism of U.S. Pat. No. 5,689,644 is limited in that it requires the use of devices that have distinct input and output ports.

It is therefore desirable to provide an efficient communications protocol for use in a real-time environment to handle the transmission of large numbers of short messages.

### SUMMARY OF THE INVENTION

The present invention provides a media access control protocol that permits peer devices to pass control over the media without the need or intervention of a master control to control transmission and traffic of information messages throughout a network system. Each individual network device can grant control over the communication bus to the subsequent device in a sequence by flipping a single bit that is buried within the communications protocol of an otherwise normal message. This results in a well-controlled and extremely efficient communications protocol capable of handling large volumes of short messages.

In order to keep any lag due to protocol implementation down to a minimum, the present invention implements a special token-passing mechanism for time-critical sources (keyboards, GUI's). This unique token-passing mechanism is implied, cascading token-passing. When operating in the unique token-passing mode, network devices will listen for each other's messages and automatically take their turn in the queue. To start the process, a bus master will send a “kick start” message. Device 1, upon hearing the message, will automatically put its transmission on the bus next (sending an empty or “null” message if required). Device 2, upon hearing Device l's message, then puts its message on the bus next, and so on, until the last device is reached. The master knows when the last device is reached and automatically restarts the sequence with another “kick start” message. Occasionally (e.g. once every 100 times through the queue), the master will check for additional devices that may have been added to the network since the last “kick start” message, and will then send another “kick start” message to start the process.

The cascading token passing method of the present invention reduces the overhead of the traditionally polled network system by about one-half since it eliminates the need for the bus master to generate a poll for each message. The devices in the present system should be sequentially numbered for maximum efficiency. However, skips in the middle of the queue, or the addition of devices to the queue can be accommodated with a corresponding reduction in efficiency (as with any polled protocol). This is because skips cannot always be avoided (since network devices are not perfect), and because additional devices may be added or removed on the fly.

When a device in the middle of the queue fails to generate an appropriate message during the assigned slot (a “skip”), the master will wait for a time-out period, and then will generate a “null” message for the non-responsive device in order to keep the token-passing process going. After an established, but changeable, number of consecutive passes through the queue with the same device not responding (e.g. three passes, although any number may be established, and the number may be changed), the bus master will consider the device “dead” and may generate a message to this effect to the system user. Thereafter, the master will send a “null” message for the non-responsive device each time it is reached in the queue; however, according to another established, but changeable, setting (e.g. every twentieth time through the queue), the master will periodically check to see if the non-responsive device is back on line. This is done by sending a message to the device and waiting for a reply. If there is no reply after a time out, then the master will resume skipping the device by generating a “null” message for it until the next periodic check, and so on.

The time it takes to transmit a message and receive a response depends on the physical layer and network being employed. In general, the time-out should be kept to the minimum necessary to reliably detect that transmission has occurred. A network based on gigabit Ethernet should have a shorter time-out than a network using a 1200-baud modem and long distance telephone service. In general, the timeout should be a little more than twice the minimum time it takes to detect a dead bus.

For example, if the bus is running at 1,200 baud and each character can be detected as it comes in, then the timeout period should be about 0.017 of a second. This is derived as follows:

1/1200=time of 1 bit=0.00083333

10 bits per byte=0.0083333

2* the minimum detection period of one byte=0.01666666

Once a device is marked as dead, the bus master must fill in a null message to keep the token passing from device to device. For dead devices, the bus master fills in the message without any delay.

When the device is repaired and returned to the system, the device will power-up in the off-line state. Occasionally, the bus master will attempt to send a message to the device to turn it on. When the device responds to this message, it can take it's normal place in the queue and the bus master will stop filling in for it.

There may also be numerous open device positions at the end of the queue. After the first few passes through the queue, the master has identified all of the responsive and non-responsive devices in the queue. The non-responsive devices at the end of the queue may simply be empty slots. Again, the master will periodically check, according to a changeable preset number, each of the non-responsive slots at the end of the queue to determine whether any devices have been added to the queue. This is similar to the handling of skips described above.

The highest numbered device is the last device in the token queue. The bus master is responsible for checking to see if any device has been added to the end of the token queue. Normally, when the end of the token queue is reached, the bus master will immediately start the queue again without delay. Occasionally it will try to turn on the next device in the queue. If a device responds, the bus master will update its record of the highest numbered device on the bus and the new device will take its place in the token queue. Thus, any device designed for this protocol should power up in a listen only mode. Until such time as the bus master sends a message to turn on the device, it should not attempt to transmit.

Certain devices may require priority in the queue, while others do not. In order to handle this situation, the priority devices are identified to the master. For efficiency, it is preferable, although not necessary, that these devices be located in consecutive positions, preferably at the beginning of the queue. In order to give them priority, when the token is passed from the last of the priority devices, the master causes the token from the last of the priority devices to go to the first of the priority devices (e.g. a “kick start”), thereby skipping all of the non-priority devices. In order to give the remaining devices access to the queue, after a changeable preset number of passes through the priority devices (e.g., five passes), the master will allow the token to be passed from the last priority device to go to the first non-priority device where it travels through all of the non-priority devices. Thus, in this example, five out of every six passes through the queue only address the priority devices, with every sixth pass traveling through the entire queue.

The unique addressing scheme of the CCTV surveillance camera system communications protocol consists of a variable-length electronic address that controls routing of information from one device to others (as in video output from a specific camera to a specific monitor and to a specific video recorder) within the network. A single byte destination address is, by definition, a local bus address. This indication makes it easy for a bridge, router, or hub to identify traffic that it must handle.

It is therefore a primary object of the present invention to provide a highly efficient media access protocol for use in real time systems.

It is also a primary object of the present invention to provide a media access protocol that may efficiently transmit large numbers of short messages over a data bus.

It is another object of the present invention to provide a media access protocol that allows bandwidth to be used efficiently so that the user interface has immediate and complete control over a device.

It is another object of the present invention to provide an efficient protocol for use in closed circuit television security systems.

It is another object of the present invention to provide a cascading token passing system for granting the right to control access to the transmission media in which sequential devices on a queue pass the token to each other in sequence, and a master device restarts the sequence each time the end of the sequence is reached.

It is also an object of the present invention to provide a cascading token passing system for granting the right to control access to the transmission media having sequential devices on a queue in which a master device keeps track of skips in the queue (from failed or non-present devices) as well as the location of the end of the queue.

It is also an object of the present invention to provide a cascading token passing system for granting the right to control access to the transmission media having sequential devices on a queue in which a master device periodically checks for new devices in the queue, checks the status of “dead” devices in the queue, and checks for devices added to the end of the queue while maintaining all such status information.

It is a further object of the present invention to provide a cascading token passing system for granting the right to control access to the transmission media having sequential devices on a queue in which a master device is capable of controlling the media by giving certain devices priority over other devices.

Additional objects of the invention will be apparent from the detailed descriptions and the claims herein.

### BRIEF DESCRIPTION OF THE DRAWINGS

FIG. 1 is a schematic diagram of the layout and byte sequence of the communications protocol of the present invention.

FIG. 2 is a table of the bits comprising the control byte.

FIG. 3 is a table illustrating the meanings of different combinations of the bus grant bit and response required bit.

FIG. 4 is a schematic diagram of the addressing byte scope.

FIG. 5 is an illustration of different command groups.

FIG. 6 is an illustration of the structure of the data area of the protocol.

FIG. 7 illustrates a 16-bit check sum for the communications protocol.

FIG. 8 is a table of characteristics of the checksum utilizing John G. Fletcher's checksum as presented in IEEE.

FIG. 9 is an illustration of byte stuffing used to maintain the uniqueness of the header byte.

FIG. 10 is an illustration of a single bus system.

FIG. 11 is an illustration of a multiple bus, single master system.

FIG. 12 is an illustration of a high speed backbone system.

FIG. 13 is an illustration of an undirected graph.

FIG. 14 is a matrix representation of the undirected graph of FIG. 13.

### DETAILED DESCRIPTION OF THE PREFERRED EMBODIMENTS

The real-time networking communications protocol of the present invention will be described herein with reference to a CCTV security systems communications network. However, it should be understood that the communications protocol of the present invention is applicable in more generic communications network systems.

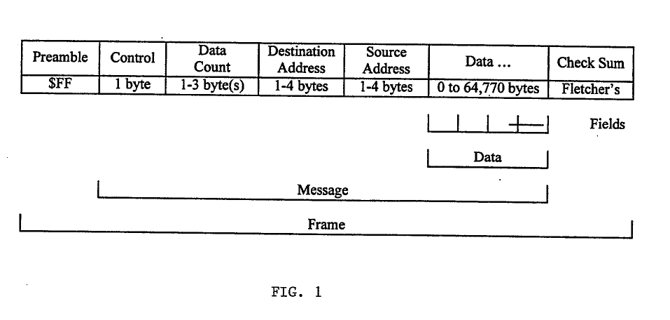

Turning now to the drawings, and specifically to FIG. 1, the communications protocol of the present invention comprises the following seven fields: (1) a preamble comprising one byte; (2) a single byte control; (3) a data count of one to three bytes; (4) a destination address of one to four bytes; (5) a source address of one to four bytes; (6) a data field comprising zero to 254 bytes; and (7) a checksum field. This protocol scheme results in a minimum message length of seven bytes. The novelty in this seven-byte protocol is the ability to recognize messages that are for the local bus, and restricting the network to having a single master on each bus to control the token passing mechanism.

The preamble field comprises the two-byte pattern $FF and $FF. This pattern is guaranteed to occur only as a preamble to a new message. Each receiving device can therefore easily identify where individual messages begin, even if it does not recognize anything else about the format of that message. All devices must be able to detect and respond to the preamble at any time in the data stream. The appropriate reaction is to reset the receiver/parser, and begin receiving the new message. The value ($FF) must occur only at the heads of messages.

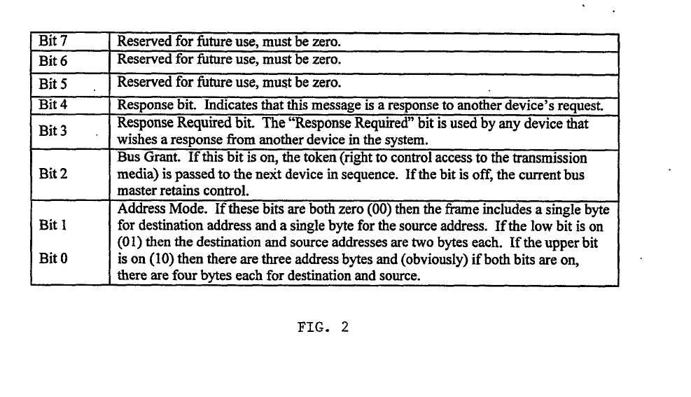

The control byte is a bit-oriented field. A bit definition is outlined in FIG. 2. As shown, bits 5, 6, and 7 are reserved for future use and should be zero. One of the remaining bits (e.g. bit 2) is designated as the bus grant bit. It is turned on only when a device that has the token (the right to control access to the transmission media) is ready to pass control over the communications media to the next device. The effect of turning on this bit is to grant the next device in sequence control over the bus. Therefore, each device that has control over the bus and uses the bus leaves the bus grant bit off in its messages until it is finished with the bus. When a particular device is finished with the bus, it will turn the bus grant bit on in a subsequent message. This bus grant on should be included in the bus control device's last message to one of the other devices within the network system, or the bus control device can create a “null” message for the sole purpose of having its bus grant bit on in the message, thereby passing the token to a subsequent device.

For example, Device No. 7 within a network has control over the bus (therefore the bus grant bit No. 4 is off in communications Device No. 7 sends to other devices). Device 7 then sends a communication to Device No. 60, the communication requesting specific information from Device No. 60. In the communication from Device No. 7 to No. 60, the bus grant bit will be off, maintaining the control over the bus in Device No. 7. Nevertheless, Device No. 60 is required to respond to Device No. 7, and does so with the bus grant bit off on in its response message. In this example, Device No. 60 is not granted control of the bus even though it is required to respond to Device No. 7. Device No. 7 retains control over the bus until it sends a communication with its bus grant bit on. As noted, this can be the last message sent or Device No. 7 can create a “null” message with the grant bit on. In the just-described sequence, because Device No. 7's last communication was requesting information from another device, this communication required that its bus grant bit be off. Therefore, in order to pass control of the bus to the next subsequent device, Device No. 7 must now create a “null” message with the bus grant bit on. When this “null” message is sent over the network, control over the bus is passed from Device No. 7 to Device No. 8.

If, on the other hand, Device No. 7 communicates with Device No. 60 with a message that is not requesting or expecting a response from Device No. 60, this last communication from Device No. 7 should be sent with the bus grant bit on, thereby passing control of the bus from Device No. 7 to Device No. 8 in the same communication from Device No. 7 to Device No. 60.

It should be noted that the grant bit is only considered valid to a device if the source of the message is local to the device's bus. Thus, sending a message from one bus through the network may set the grant bit to pass the token on it's bus, but the grant bit will be ignored on the destination bus since the message did not originate on the same bus.

The “response” and “response required” bits (e.g., bit 3 and bit 4) perform two distinct functions. One bit (e.g. bit 4) is the response bit, used by any device that is responding to a query from another device. Any device that is responding to another device's query has temporary possession of the token (right to use the bus). This temporary possession lasts for a single message and may not be passed on by using the “bus grant” bit. The token automatically reverts to the device that requested the response.

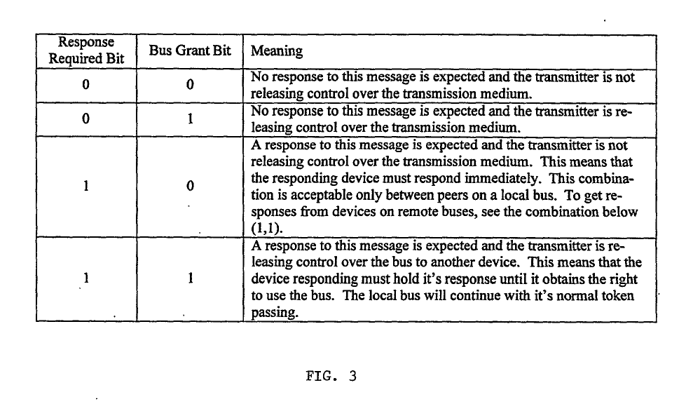

The “response required” bit (e.g. bit 3) is used by any device that wishes a response from another device in the system. Any device receiving a command with the response bit on must respond, even if it is just a NAK. The bus master must time out for any device that does not respond. If the device being polled does not respond, the bus master must send a NAK for that device, to keep the token moving. FIG. 3 details the meanings of different combinations of the response required bit and the bus grant bit.

The address mode bits (usually bit 0 and bit 1) provide information about how many bytes of addressing information a message contains. Each message can contain 2, 4, 6 or 8 bytes of addressing information. The frame will contain the addresses for the source and destination of the communication, and the destination and source addresses will have the same number of bytes. If these bits are both zero (00), then the frame includes a single byte for destination address and a single byte for the source address. If the low bit is on (01), the destination and source addresses are two bytes each. If the upper bit is on (10), there are three address bytes. Similarly, if both bits are on, there are four bytes each for the destination address and source address. See FIG. 2.

The first data count byte allows the user to send from 0 to 253 bytes in a single message. The count byte may be extended for larger message by using 0×FE. If the count byte is 0×FE, then the next two bytes are used to determine the actual count of the data section. The first byte (0×FE) is multiplied by the second byte (1−0×FE) and then added to the third (0−0×FE) for a total of 64,770 possible bytes. Of course, while the protocol allows a large number of bytes in a single message, this is not recommended on a bus where data must flow in real time. The count is the number of bytes in the expanded data (not compressed).

The real-time network protocol of the present invention utilizes two distinct types of addressing, local and network. The network protocol will be used primarily with local addressing because most CCTV video surveillance systems are local systems. Because of this, the protocol utilizes a very short local addressing system, specifically a single byte address. Network addressing utilizes longer, multiple byte, addresses.

Local addressing is associated 1 to 1 with a device ID, and is in the range $01−$FD. This provides 252 local device addresses. Address $00 is used as a placeholder, and address $FE is used for “all-call”. “All-call” is a broadcast message intended for all devices on a bus. Address $FF is reserved for future use.

The addressing information in the network addressing mode includes from four to eight bytes. A single byte address refers to messages within a bus. A two-byte destination and source address refer to devices within the local group controlled by a hub. A three-byte destination and source address references all devices within a network (backbone). A four-byte address refers to messages that are directed between backbones.

In all cases, the address must include the lower address or device byte. It is not possible to address a message to a hub by simply indicating the network number and hub number. This would be interpreted as being the bus number and device number, rather than the network number and hub number. A hub acts like any other device on the local bus and is not assigned any particular device address. When messages are destined for outside the local bus, it is the job of the hub to pass the information on to the correct bus. When the hub has its turn on the local bus, it is then able to pass the message from the outside to the local bus.

In all instances, the address $FE is reserved for the All-Call function, and address $FF is reserved for future use. The bus master is address 0 for all local buses. The bus master sets address of system master when devices power up. The system master, if it exists in a system, is the device that handles system level arbitrations. This includes such things as: logging on to the system, permission to use certain devices, user priorities, etc.

The bus master sets the upper bytes of the address for local devices. Most local devices will have the ability to set only their local address through switches. The bus master must be aware of it's location in a system and will, when it powers up a new local bus device, tell that device what the upper three bytes of the address are.

The bus master, when filling in for a failed device, must use the failed device's address as the source. This means that the receiving device must accept a response from the device queried or the bus master. This is because the bus master looks at all responses and may incorrectly decide that a device is OK when it's really dead (especially when we design systems with redundant bus masters).

If the system master address is unknown one can perform an all call for a system management function. The system master will return its address with the response. But no other device is supposed to respond to all calls!

It is to be noted that the addressing information held in the protocol is not intended to imply nor specify a path to a device. It is only used to uniquely identify the location of a device in the system, allowing for intelligent, adaptive routing of information (see the section on message routing).

Data fields may include special contents. One of these special contents is message tagging (known as “CTAG” in the telecommunications industry). Message tagging allows a system master to send a large number of messages out to various devices without waiting for responses. Each message has a unique number or “TAG” that directs the response back to the system master initiating the message. When the device responds to the initial message, the device attaches the tag number to its response, directing the response back to the system master, and enabling the system master to associate that particular response with the original message.

Message tagging provides a major advantage in systems where remote devices may not be able to respond to certain commands in real-time. Message tagging adds the overhead of an additional byte or so to some messages, but ensures that the system master can operate the system without waiting for particular responses. In the instant protocol, message tagging is found in the data base description.

The data field also permits the use of individual bits of information. Each bit is considered to be a separate element of the data base. To maintain protocol efficiency, the data bases should be designed to keep bit-sized elements together. When consecutive elements within a data base are all bits, they can be combined into bytes. When a number of bits are combined into a byte, the least significant bit becomes the lowest numbered element. If the number of bit-sized elements is not an even multiple of eight, the last byte is filled with “no” (0) bits.

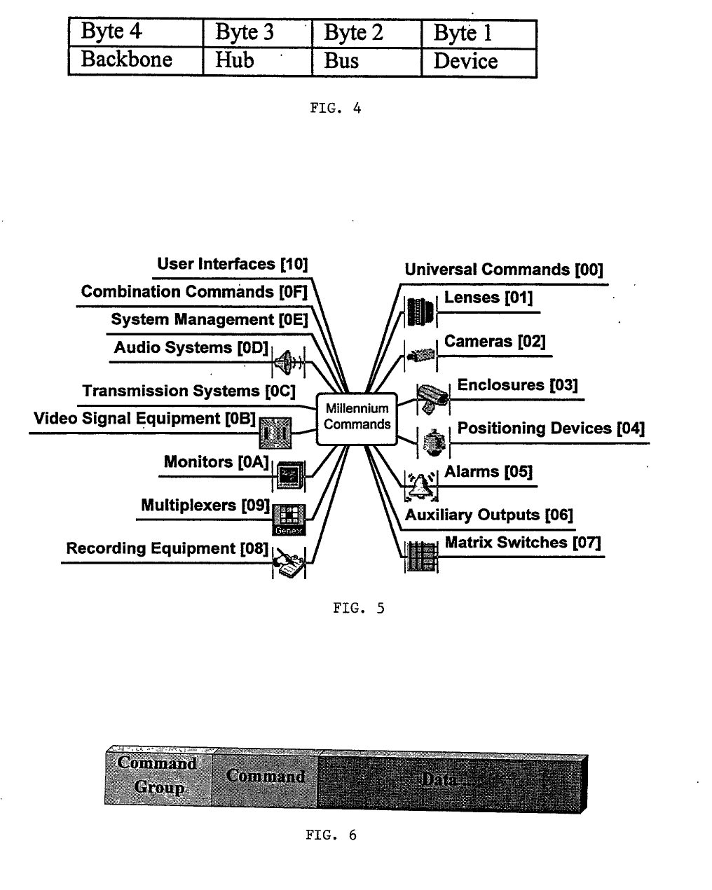

Commands within the “M” protocol are two bytes long. The first byte indicates the command group (as shown in FIG. 5). The second byte indicates the specific command. Within a data field, the command group comes first, then the command, then any data associated with that command:

| | |
|---|---|
| 00 | Universal Commands |
| 01 | Lenses |
| 02 | Cameras |
| 03 | Enclosures |
| 04 | Positioning Devices |
| 05 | Alarms |
| 06 | Auxiliary Outputs |
| 07 | Matrix Switches |
| 08 | Recording Equipment |
| 09 | Multiplexers |
| 0A | Monitors |
| 0B | Video Signal Equipment |
| 0C | Transmission Systems |
| 0D | Audio Systems |
| 0E | System Management |
| 0F | Combination Commands |
| 10 | User Interfaces |

FIG. 7 illustrates the checksum utilized in the networking protocol of the present invention. As shown in FIG. 7, for all message bytes B: C(0) is the sum of all bytes, modulo 256; and C(1) is the sum of all sequential values of C(0), modulo 256.

To use the checksum in the instant networking protocol, the sending device performs an additional calculation to result in the receiving device having zeros in both bytes when the checksum calculation includes the checksum field. This permits the receiving device to check for validity quickly and easily by checking for zeros in both bytes of the checksum field (“or” the values together and check for zero).

A pseudo-code implementation of the full algorithm is:

C0=0

C1=0

While (there are more bytes to transmit)

C0=C0+byte

C1=C1+C0

transmit byte

End While

C0=C0 modulo 256

C1=C1 modulo 256

C0=((256−C0)+(256−C1)) modulo 256

transmit C0

transmit C1

There is also a relatively simple algorithm that can be used to calculate a checksum using only the changes in a message. The formulas for this are:

Given:

ML is the message length

K is the location in the message

S1 is the old character

S2 is the new character

C0=C0−(((ML−k) +1)*(S2−S1))−(S2−S1)

C1=C1+((S2−S1)*(ML−k))+(S2−S1)

C0=C0 modulo 256: modulo 256 to keep it to a byte

C1=C1 modulo 256

if C0<0 then C0−C0+256: make sure it's not negative

if C1<0 then C1−C1+256

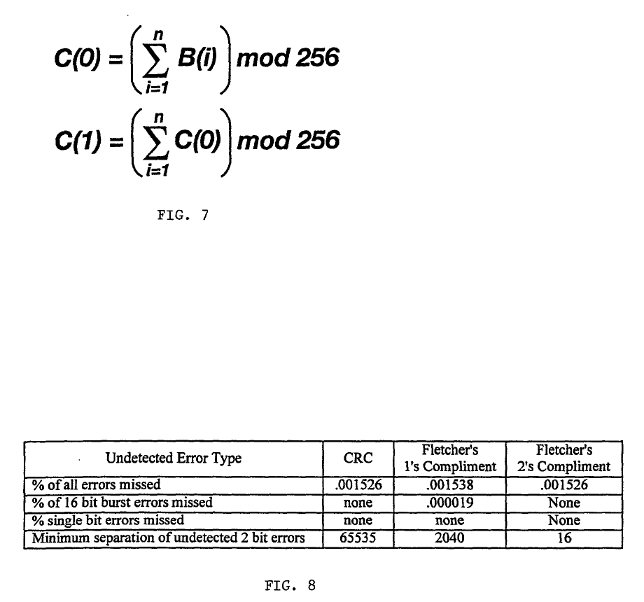

FIG. 8 is a table of characteristics of the checksum utilizing John G. Fletcher's checksum as presented in IEEE. The checksum is calculated over the length of the message. As described above, the message portion of the protocol does not include the preamble. The checksum is calculated on the expanded data. This means that one must perform the substitutions for $FF and $FE before calculating the checksum.

To keep the header byte ($FF) unique in the data stream, the present protocol uses “Byte Stuffing.” Byte stuffing is the practice of changing bytes into alternative byte patterns and changing them back to the original bytes when they are received. In this protocol the value $FF is changed to $FE, $FE. This means that the value $FE must also be compensated for. $FE is changed to $FE, $FD. Fortunately, this is the extend of the stuffing scheme needed to protect the uniqueness of $FF.

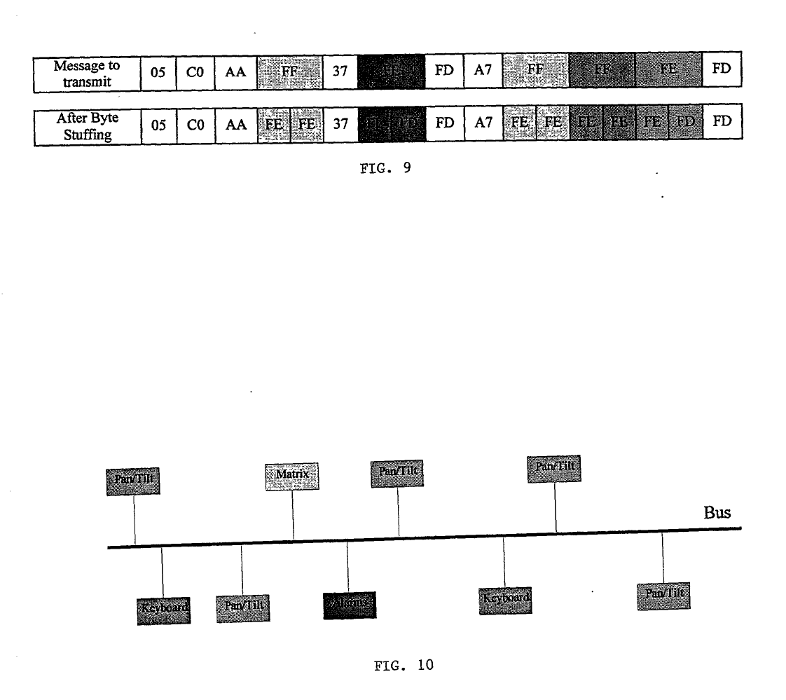

FIG. 9 shows an example of the message to be transmitted, and the result after byte stuffing. There are only two valid values that can follow an $FE in a transmission stream. Each $FE must be followed by either another $FE (to indicate the presence of the value $FF), or by an $FD (to indicate the presence of an $FE). Care should be taken to minimize the use of these values in the protocol. In other modes (the packet carrier and when downloading code, for example) these values will show up at random. This means that one could expect random messages to expand by two bytes for every 256 transmitted. Therefore, byte stuffing expands the protocol by approximately 0.78125%. Byte stuffing is applied only to the data area of the protocol.

The protocol of the present invention has the ability to carry other protocols embedded within the data field. This allows the network to serve as a “packet carrier” for other pieces of equipment. The only requirement for using the packet carrier mode is that there must be equipment capable of creating the packets and understanding the M protocol at each end. The packet carrier command is part of the universal commands and is identified by command group $00 and command $C0.

The present invention is designed to accommodate a wide variety of configurations. These configurations can all be built from a few fundamental structures. These structures (from the smallest single bus to a full local area or wide area network) allow great flexibility in sizing and upgrading systems.

The simplest system design is a single bus. A single bus consists of a single communications channel that is shared by all the devices in the system, as shown in FIG. 10. This limits the number of devices and distance to what can be handled by EIA-485 (and compatible equipment). Generally this is 32 receiver/transmitters and 4,000 feet. The number of receiver/transmitters can be increased to up to 256 by using the appropriate driver technology. EIA-485 specifies that the line must be capable of accommodating “ . . . 32 unit loads.” A unit load is usually thought of as being a single device but many manufacturers now offer half load, quarter load and even eighth load devices. Using eighth load devices allows 8*32=256 devices on a single bus.

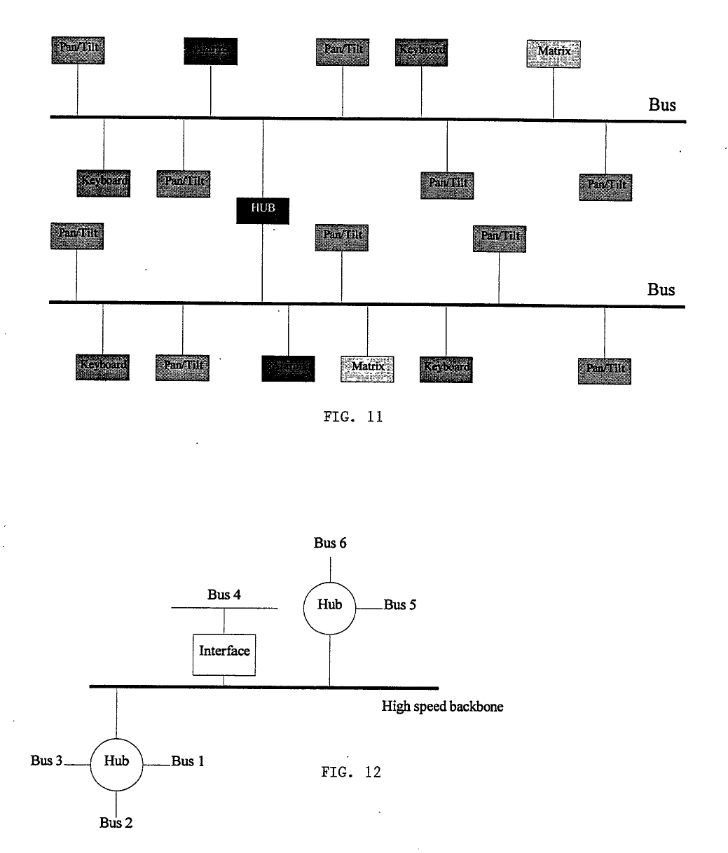

In any system of the present invention, each bus must have a bus master (a device that is responsible for managing the communications traffic). In the diagram of FIG. 10, the matrix would be a logical candidate for performing the bus master tasks. If a system benefits from having more than one bus (either to increase the number of devices, for physical layout reasons, for partitioning, etc.), the system can be designed with multiple buses. In such a case, a device must be selected to serve as a “hub”. In some cases, the system may require a dedicated device to serve as the hub. In the diagram of FIG. 11, a dedicated hub controls both buses. A hub may, in fact, control multiple buses. The only limit being how fast the hub runs and how much traffic there is on the buses.

In the largest systems, a high speed backbone will be used. This backbone may be any of a variety of high speed digital communication channels. It may, for example, be: Ethernet, FDDI, ATM, etc. The system configuration is shown in FIG. 12.

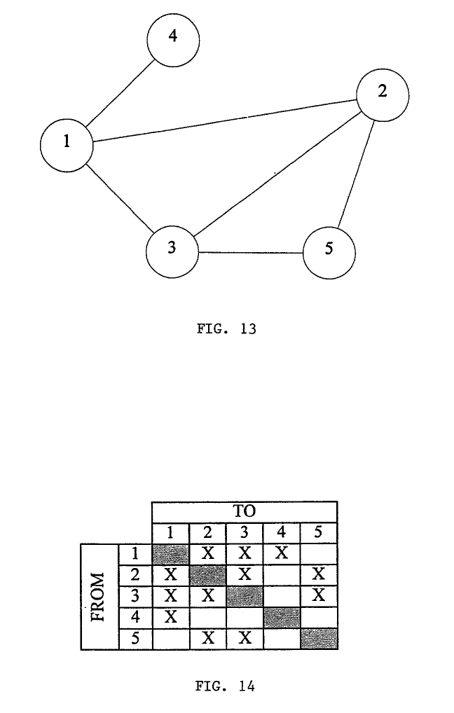

The present invention is designed around a specific routing algorithm. Each device in the system that is responsible for routing information should use the same algorithm to help achieve consistent system performance. The algorithm is based on an undirected graph (FIG. 13). This assumes that all pathways are bi-directional. A directed graph would also show the direction of each path with an arrow at one end of each line. The graph of FIG. 13 does not need those indicators since all paths are bi-directional. The graph shows that there are three ways for device one to reach device two. They are: 1-2, 1-3-2, and 1-3-5-2. A matrix can be used to duplicate the information of the directed graph as shown in FIG. 14.

It's worth noting that the graph of FIG. 14 is symmetrical. That is because all of the paths are bi-directional. Therefore, one needs only the upper right half or the lower left half of this table. Since the paths are bi-directional, if there is a path from 1 to 2, then there must also be a path from 2 to 1. When implementing the routing algorithm in code, this graph can be kept as a bit map called an “ad-acency matrix”. In an adjacency matrix, each bit represents one of the lines in the undirected graph.

Algorithms for navigating through an adjacency matrix from a source to a destination are well known and are available. The algorithms can be set up to find the “least cost” path from any source to any destination. The term “least cost” is used to identify a preferred path based on a variety of different criteria. The cost of a path may be the cost in dollars of using the path, or the cost in time, or the cost in available bandwidth. For the purposes of the M protocol, the least cost is defined as the available path that routes through the fewest number of nodes. Not all hubs, nodes, etc. in the present system will have the ability of performing this intelligent routing function. The potential for this functionality should be kept in mind for future use. It is to be noted that the addressing information in the protocol is not meant to imply a path to a device, but only to uniquely identify a device and its location in a system.

The most common type of bus control is the single bus master. In this situation, however, if the bus master dies, that bus will not function fully until the bus master returns to service. Some limited functionality of the system will continue but that will depend on the system configuration.

In some cases it will not be acceptable to have a bus “crash”. In these cases, it is recommended that a redundant bus master be installed. A redundant bus master is a device that sits around doing nothing until the primary bus master dies. As soon as the primary dies, the redundant bus master takes over and begins operating the bus.

Many systems will have a “System Manager” to help coordinate activities in the system. The system manager controls Contention Problems (where, for example, two users are trying to use the same pan/tilt device at once), Macros (the system manager will run macros), System Log (the system manager will keep a log of system events), and Help (the system manager will display information to the user based on a variety of criteria (e.g. alarms, time of day, etc.)).

Some systems will require a redundant system manager. Like the redundant bus master, the redundant system manager does nothing until the existing system manager fails to function. At that time, the redundant system manager will take over the duties of the primary. In some larger systems, or in systems that are partitioned, there may be more than one system manager. In these cases, each manager in the system will control a fixed area of the network. Any attempts to operate equipment from one area of the network to another area will be subject to the scrutiny of the appropriate system manager.

In the preferred embodiment, every bus in the system must have one, and only one, bus master at a time. Redundant bus masters may be available, but only one may be in use at any given time. When the bus master powers up, the bus master must first send an “all call” to turn all devices off-line, and then try to turn on every device on the bus (automatic configuration). The bus master must keep track of and be able to report when queried regarding which devices on a bus are on-line, which are present but not responding, and which are not present at all. The bus master must mark a device as failed after a set number (e.g. three) consecutive failures to respond to a bus grant. The bus master must fill in a “null” message for all failed devices to keep the token passing mechanism operating. The bus master must try to turn on failed devices without causing unacceptable delays in the token passing mechanism. A typical scenario would be an attempt to turn on a single device on each pass through the queue. The bus master must be solely responsible for detecting and reacting to “dead air.” If the bus is idle for a given length of time, the bus master must recognize this as an error and begin recovery procedures. Finally, the bus master's timeout period (e.g. for failed devices) must be defined. If possible, it should be adjustable to accommodate slow devices. Preferably, the bus master should be able to set the timeout on a device by device basis (by address).

It is also preferred that peer devices not deal with bus timing. There is no timeout that a slave device must detect—that is the responsibility of the bus master. Peers should not respond to “all call” messages, but only to a message that is directed to that peer device individually. All peer devices (not the bus master) should power up into an off-line state, leaving it to the bus master to turn the device on. Finally, whenever possible, data should be designed to avoid use of the preamble bytes ($FF and $FE) as much as possible. These bytes expand to two bytes during transmission and reception (because of byte stuffing, described above) and are therefore slower than others in the system.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. A frame for a message in a real-time network protocol for controlling the routing of information on a data communications network, comprising:
a preamble field having a single-byte pattern;
a single-byte control field;
a data count field having from one to three bytes;
a destination address field having from one to four bytes;
a source address field having from one to four bytes;
a data field having from zero to 254 bytes; and
a 16-bit checksum field.

2. A real-time network protocol for controlling the routing of information on a data communications network among a plurality of peer network devices comprising a token passing structure for granting message transmission rights on the network having a one-byte control field in each message from one of said devices wherein said control field includes a single grant bit for determining whether the right to control access to the network is to be maintained by the said device generating the message or passed to the next sequential device of said plurality of devices.

3. The protocol of claim 2 wherein said one-byte control field includes a response required bit for indicating whether or not a response is required from one of said plurality of devices to the message from said message generating device.

4. The protocol of claim 3 wherein said one-byte control field includes a response bit for indicating whether or not the message containing the bit is a response to a request from another device.

5. The protocol of claim 4 wherein said one-byte control field includes a pair of address mode bits for indicating the number of source and destination address bytes used in the message.

6. The protocol of claim 5 wherein the value of said pair of address mode bits indicates one of the following conditions: the message contains a one-byte source and destination address; the message contains a two-byte source and destination address; the message contains a three-byte source and destination address; the message contains a four-byte source and destination address.

7. A method of communicating between a plurality of peer network devices in a queue on a data communications network, one of said devices being a master device, and each of the devices having the ability to pass a token for granting message transmission rights on the network, the method comprising the steps of:
a. generating a message within one of the plurality of peer network devices, the message including a single-byte control field, the single-byte control field including a grant bit that determines whether the said peer network device intends to pass the transmission rights token to the subsequent sequential peer network device on the queue;
b. sending the generated message to the data communications network;
c. the subsequent sequential peer network device determining from the message control field grant bit whether the token is to be passed to it;
d. passing the token according to the message control field grant bit;
e. the intended message destination device receiving and complying with the generated message;
f. repeating steps “a” through “e” above for each sequential peer network device until token is passed to the last device in the queue;
g. the master device passing the token from the last device to the first device in the queue;
h. continuously repeating steps “a” through “g.”

8. The method of claim 7 including the additional steps of:
i. the master device identifying any non-responsive peer network device in the queue; and
j. the master device generating a message and passing the token for said non-responsive device each time through the queue.

9. The method of claim 8 including the additional steps of:
k. the master device occasionally checking any non-responsive peer network devices for a response; and
l. the master device returning each such responsive device to the queue.

10. The method of claim 9 including the additional steps of:
m. the master device occasionally checking beyond the end of the queue for additional new devices; and
n. the master device adding each such additional device to the queue.

11.The method of claim 10 including the additional steps of:
o. the master device establishing a plurality of sequential priority devices on the queue;
p. the master device passing the token from the last priority device to the first priority device on the queue;
q. the master device occasionally allowing the token to be passed from the last priority device to the next sequential non-priority device in the queue.
